(19) United States
(12) Patent Application Publication
(10) Pub. No.: US 2005/0073916 A1
(43) Pub. Date: Apr. 7, 2005

(54) Apparatus and method for reproducing sound

(75) Inventor: Masamichi Kotera, Saitama (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Sony Corporation, Tokyo (JP)

(21) Appl. No.: 10/918,409

(22) Filed: Aug. 16, 2004

(30) Foreign Application Priority Data
Sep. 3, 2003 (JP) 2003-311569

(51) Int. Cl. G11B 7/085

(52) U.S. Cl. 369/30.04

(57) ABSTRACT

An operation to skip plural pieces of music continuously is performed in a reproduction order or a reversed reproduction order circularly. When a piece of music to be reproduced first is selected, identification sound deciding that the piece to be reproduced first is selected is output. Hearing the identification sound allows it to be decided that the piece to be reproduced first is selected without using any display. When the piece to be reproduced first is selected, the skip is stopped to start its reproduction, thereby enable its selection to be surely decided. Every time the piece of music to be reproduced second or later is selected in a continuous skipping operation, the switchover sound different from the identification sound is output.

### BACKGROUND OF THE INVENTION

1. Field of the Invention

The present invention relates to apparatus and method for reproducing sound.

2. Description of Related Art

Conventionally, an apparatus for reproducing sound contents such as pieces of music recorded in a recording medium is provided with a skip function to enable search for desired contents in a short lapse of time. This skip function includes forward skip function to advance sound contents in a direction of a reproduction order and backward skip function to advance them in a direction opposite to the reproduction order. The skip function also includes consecutive skip function to skip sound contents consecutively.

Further, it is carried out to skip the contents by a desired amount thereof or to a desired location depending on a lapse of time when a skip instruction device is operated.

When desired sound contents are searched utilizing the skip function, if providing the apparatus for reproducing sound with a display portion to display information on the sound contents selected during skipping operation and stopping the skipping operation when the desired sound contents have been selected, the desired sound contents are lightly reproduced. However, in a case where the apparatus for reproducing sound is provided with no display portion or where the apparatus is portable and put in a pocket or a bag and so indication on the display cannot be visualized, when sound contents are being skipped consecutively, it is impossible to know what number sound contents are selected currently. Further, if it is not known what number sound contents are being reproduced, the number of skip operations to be performed until desired sound contents is encountered cannot be known either. Especially when the sound contents are selected circularly by consecutive skip operations, it is completely impossible to know what number sound contents are selected.

### SUMMARY OF THE INVENTION

It is an object of the present invention to provide an apparatus and a method for reproducing sound that enables selection of sound contents to be reproduced first or such sound contents as to have a desired turn in reproduction order using no display during consecutive skip operations.

In order to accomplish the object, as an aspect of the present invention, there provides an apparatus for reproducing sound. The apparatus comprises a reproducer for reproducing plural sound contents in accordance with a reproduction order thereof and an operating device for operating to skip the sound contents reproduced by the reproducer. The apparatus also comprises a controller for skipping the sound contents circularly in a reproduction order thereof or a reversed order of the reproduction order in accordance with an operation of the operating device to select new ones from the sound contents, and for controlling the reproducer to reproduce the newly selected sound contents, and a sound-outputting device for outputting the reproduced sound contents. When the operating device operates to skip the sound contents and the controller selects the sound contents, which is to be reproduced first, the controller controls the sound-outputting device to output identification sound, from the sound-outputting device, deciding that the sound contents of a first reproduction order are selected.

As another aspect of the present invention, there provides an apparatus for reproducing sound. The apparatus comprises a reproducer for reproducing plural sound contents in accordance with a reproduction order thereof and an operating device for operating to skip the sound contents reproduced by the reproducer. The apparatus also comprises a controller for skipping the sound contents circularly in a reproduction order thereof or a reversed order of the reproduction order in accordance with an operation of the operating device to select new ones from the sound contents, and for controlling the reproducer to reproduce the newly selected sound contents, and a sound-outputting device for outputting the reproduced sound contents. When the operating device operates to skip the sound contents and the controller selects the sound contents, which is to be reproduced first, the controller stops skipping the sound contents and controls the reproducer to reproduce the sound contents.

As further aspect of the present invention, there provides a method for reproducing plural sound contents in accordance with a reproduction order thereof. The method comprises a decision step of deciding whether an operation is performed to skip the sound contents to be reproduced circularly in a reproduction order thereof or a reversed order of the reproduction order. The method also comprises an identification sound output step of, when it is decided by the decision step that the operation to skip the sound contents is performed, circularly skipping the sound contents in the reproduction order or the reversed order and, when the sound contents of a first reproduction order are selected, outputting identification sound deciding that the sound contents of the first reproduction order are selected.

As still further aspect of the present invention, there provides a method for reproducing plural sound contents in accordance with a reproduction order thereof. The method comprises a decision step of deciding whether an operation is performed to skip the sound contents to be reproduced circularly in a reproduction order thereof or a reversed order of the reproduction order. The method also comprises a reproduction step of, when it is decided by the decision step that the operation to skip the sound contents is performed, circularly skipping the sound contents in the reproduction order or the reversed order of the reproduction order and, when the sound contents of the first reproduction order are selected, stopping skipping the sound contents and reproducing the sound contents.

According to the present invention, such an operation is performed as to continuously skip plural sound contents, which have been recorded in a recording medium and have fixed turns in reproduction order, in a reproduction order or a reversed reproduction order circularly. Thus, when sound contents to be reproduced first are selected, the identification sound deciding that the sound contents to be reproduced first are selected is output or, each time when the sound contents different from the sound contents to be reproduced first are selected newly, the switchover sound different from the identification sound is output. Further, if the sound contents to be reproduced first are selected, the skip operation is stopped to reproduce them.

The concluding portion of this specification particularly points out and directly claims the subject matter of the present invention. However those skill in the art will best understand both the organization and method of operation of the invention, together with further advantages and objects thereof, by reading the remaining portions of the specification in view of the accompanying drawing(s) wherein like reference characters refer to like elements.

### BRIEF DESCRIPTION OF THE DRAWINGS

FIG. 1 is a block diagram for showing a configuration of device for reproducing sound;

FIG. 2 is a table for showing a reproduction list;

FIG. 3 is a flowchart for showing a skip operation; and

FIGS. 4A and 4B are drawings each for explaining consecutive skip operations.

### DESCRIPTION OF THE EMBODIMENTS

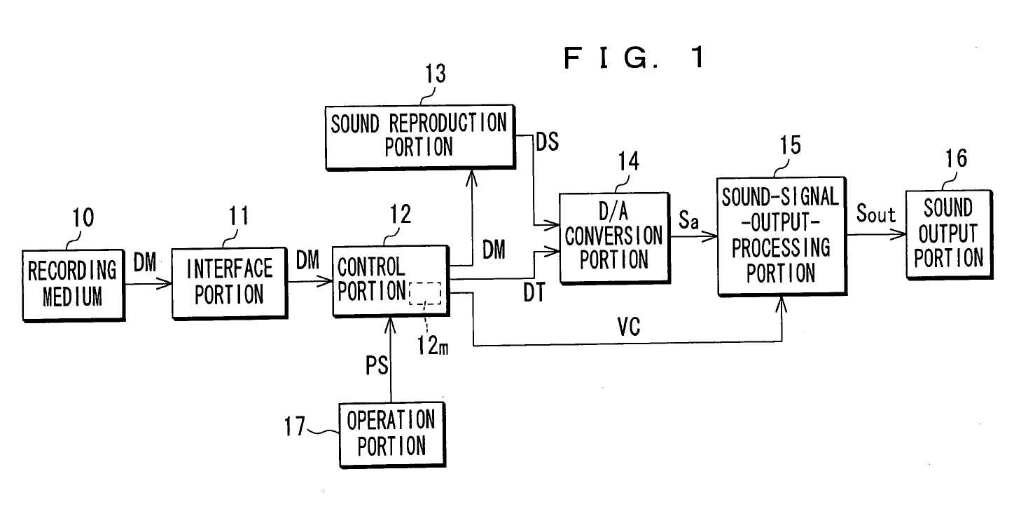

The following will describe embodiments of the present invention with reference to drawings. FIG. 1 shows a configuration of an apparatus for reproducing sound. This apparatus reproduces a signal for sound contents recorded in a recording medium constituted of, for example, a flash memory. This recording medium may be attached to and detached from the apparatus or be built in it.

The recording medium records a signal of the sound contents, for example, in a compressed form. Further, the recording medium 10 records a reproduction list having information that indicates an order in which the recorded sound contents are to be reproduced and management information for reading out the signals for sound contents according to the reproduction list. Note here that the reproduction list and the management information may be held in a control portion 12, which will be described later.

Signal DM for sound contents recorded in the recording medium 10 is read out via an interface portion 11 by the control portion 12. The control portion 12 supplies it to a sound reproduction portion 13. This interface portion 11 matches the recording medium 10, so that if the recording medium 10 conforms to the universal serial bus (USB) standards, a USB interface is used as the interface portion 11. The sound reproduction portion 13 decompresses the supplied signal DM, to supply digital sound data DS thus obtained to a D/A conversion portion 14. The D/A conversion portion 14 converts the sound data DS into an analog sound signal Sa and supplies it to a sound-signal-output-processing portion 15. Based on a control signal VC supplied from the control portion 12, the sound-signal-output-processing portion 15 adjusts a signal level of the sound signal Sa to supply it as a sound output signal Sout to a sound output portion 16. The sound output portion 16 is constituted of a speaker or a headphone and outputs sound based on the sound output signal Sout.

An operation portion 17 is connected to the control portion 12. The operation portion 17 has a reproduction button for starting reproduction of the sound contents recorded in the recording medium 10, a stop button for stopping the reproduction, forward skip and backward skip buttons for selecting the sound contents, and the like, thus generating an operation signal PS in accordance with their button operation to supply it to the control portion 12.

The control portion 12 has a memory 12m. The memory 12m stores a control program for controlling operations of the apparatus for reproducing sound. The control portion 12 executes this control program, to select the sound contents from among those recorded in the recording medium 10 and read the signals for the selected sound contents out of it, based on the operation signal PS from the operation portion 17. Further, the control portion 12 generates the control signal VC and supplies it to the sound-signal-output-processing portion 15 to adjust the signal level of the sound output signal Sout. Further, the memory 12m stores the sound data DT in it, so that the control portion 12 reads the sound data DT from the memory 12m and supplies it to the D/A conversion portion 14, thereby causing the sound output portion 16 to output sound that enables a user to decide that the sound contents are switched or that the sound contents to be reproduced first is selected. Furthermore, the memory 12m is arranged to be able to store the reproduction list also in it.

An apparatus for recording sound generates the reproduction list when a signal for sound contents is recorded in the recording medium 10. The reproduction list is then recorded in the medium 10. Alternatively, the apparatus for reproducing sound judges the sound contents recorded in the recording medium 10 and, based on a result of this judgment, a reproduction list is generated and held in, for example, the memory 12m of the control portion 12. Note here that the recording medium 10 stores a file allocation table (FAT) that indicates which locations in the recording medium 10 a file of the signals for sound contents is stored in.

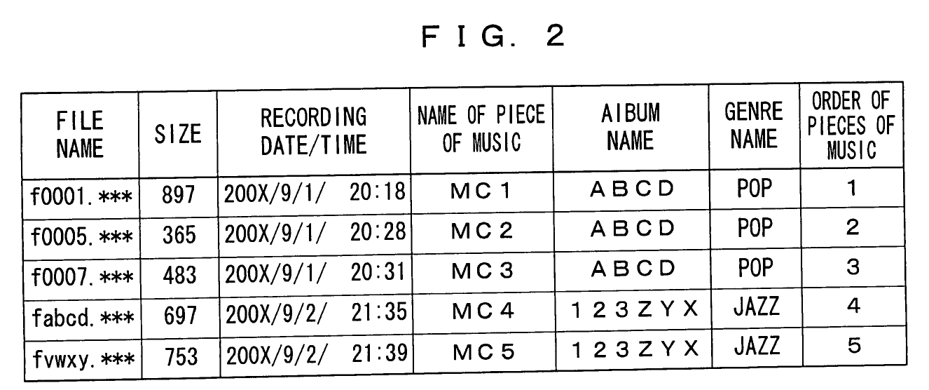

In this case, if a signal for music contents recorded in the recording medium 10, for example, a signal of a piece of music is compressed in accordance with “MPEG1Audio Layer3” standards and, an ID3 tag to provide so-called MP3 file data is added to it, information about this file and that of the ID3 tag are utilized to generate a reproduction list. As shown in FIG. 2, for example, this reproduction list comprises pieces of information such as a file name of compressed data of the piece of music, a file size, a recording date/time, a name of the piece of music, an album name, a genre name of the piece of music, and an order of the pieces of music that indicates a reproduction order thereof. Note here that the reproduction list may have at least information of the file name and the order of the pieces of music.

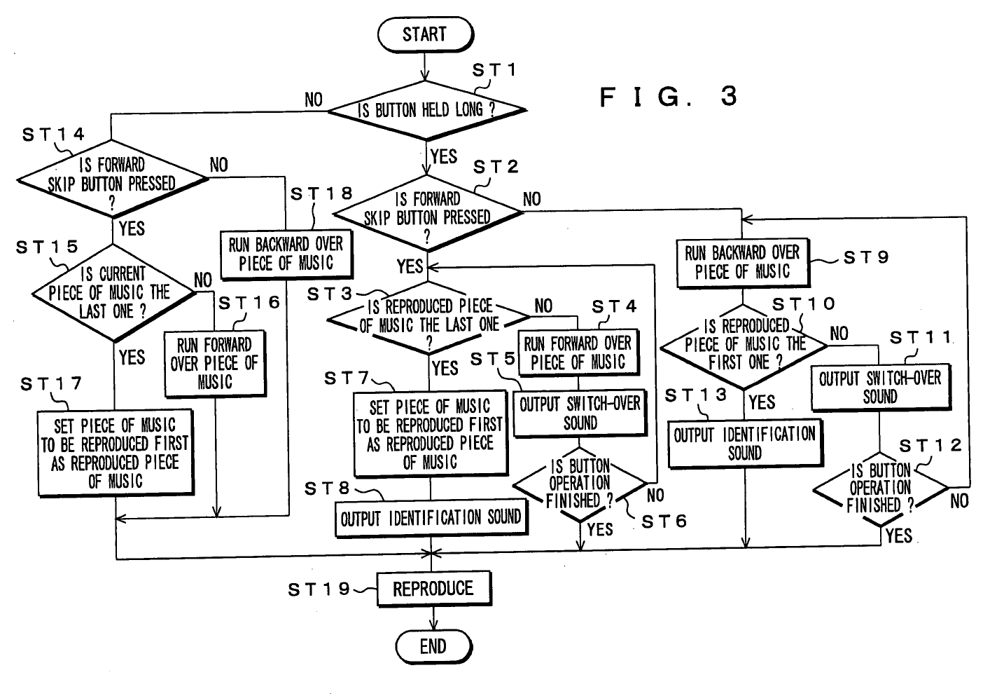

Next, skip operations are described for selecting a desired piece of music in the apparatus for reproducing sound. The control portion 12 performs process of the flow chart shown in FIG. 3 when it decides that the forward skip button or the backward skip button is pressed on the basis of the operation signal PS.

At step ST1, the process decides whether the forward or backward skip button is held long. If a lapse of time when the button is held down is longer than a predetermined lapse of time, the process decides that a hold-long operation is performed and goes to step ST2. Otherwise, the process goes to step ST14.

At step ST2, the process decides whether the button held long is the forward skip button. If such is the case, the process goes to step ST3. Otherwise, the process goes to step ST9.

At step ST3, the process decides whether a piece of music selected to be reproduced (hereinafter referred to as “reproduced piece of music”) is the last one. For example, when the apparatus for reproducing sound is started, the first piece of music is reproduced. Further, if a piece of music is reproduced after the apparatus is started, a piece of music currently being reproduced or a piece of music reproduced last is regarded as the reproduced piece of music.

If a reproduced piece of music is not the last one to be reproduced in the reproduction list, the process goes to step ST4 and, otherwise, to step ST7.

At step ST4, the process runs forward over the pieces of music to select a next piece to be reproduced from the reproduction list and set it as the reproduced piece of music.

At step ST5, the process reads out of the memory 12m sound data DTmc of switchover sound that indicates switchover of pieces of music and supplies it to the D/A conversion portion 14 so that switchover sound SUmc may be output from the sound output portion 16. As the switchover sound SUmc, beep sound is used, for example.

At step ST6, the process decides whether the button operation is finished. If such is not the case, the process returns to step ST3. Otherwise, the process goes to step ST19.

Thus, performing operations of the forward skip button sequentially allows processing from steps ST3 through ST6 to be repeated, thereby selecting the pieces of music in the reproduction list according to their order.

Then, if the piece of music to be reproduced last is selected, the process goes from step ST3 to Step ST7. At step ST7, the process sets the first piece of music, which is a piece of music to be reproduced first, as the reproduced piece of music and goes to step ST8.

At step STB, the process reads out of the memory 12m the sound data DT of identification sound indicating that the first piece of music is selected and supplies it to the D/A conversion portion 14. The sound output portion 16 outputs the identification sound SUft and the process goes to step ST19. This identification sound SUft is set so that it may be discriminated from the switchover sound SUmc easily. For example, the identification sound SUft has different lapses of time and/or frequencies from those the switchover sound SUmc has. It is also possible to distinguish between the identification sound SUft and the switchover sound SUmc by fixing the frequency of one of them and making that of the other variable. Further, composite sound indicating the first piece of music based on sound data DTft may be output as the identification sound SUft. This allows the first piece of music to be noticed easily without distinguishing between the two sounds. Further, as the switchover sound SUmc, fast reproduced sound of a piece of music etc. may be utilized. For example, a signal of the beginning of the piece of music may be read out and reproduced fast to output it in a short lapse of time.

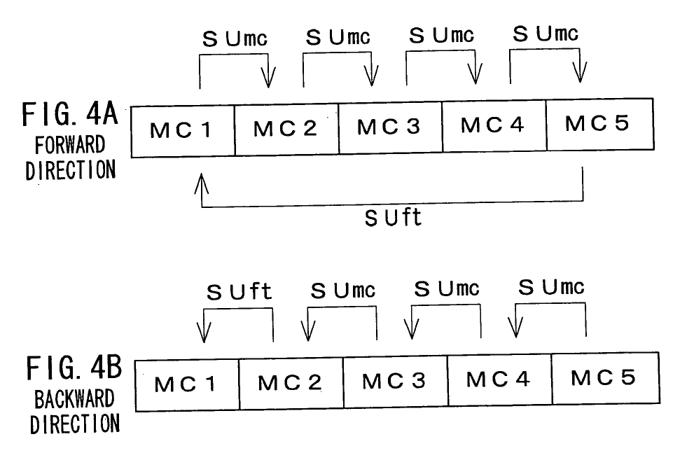

When the consecutive skip operations are performed according to the reproduction order of the piece of music, as shown in FIG. 4A, the switchover sound SUmc is output each time the pieces of music are is switched until a last piece “MC5” is encountered. When it is switched to a first piece “MC1”, the identification sound SUft is output. Therefore, it is possible to decide, based on the identification sound SUft, that the first piece is selected. Counting up the number of times the switchover sound SUmc is output thereafter allows a user to decide what number the piece of music is selected.

Next, if it decides at step ST2 that the backward skip button is pressed, the process goes to step ST9, where it runs backward over the pieces of music to select a piece of music immediately previous in the reproduction list and set the selected piece as the reproduced piece of music.

At step ST10, the process decides whether the reproduced piece of music is the first one to be reproduced. If it is not the first to be reproduced in the reproduction list, the process goes to step ST11 and, otherwise, to step ST13.

At step ST11, the process outputs the switchover sound SUmc indicative of the switchover of the pieces of music from the sound output portion 16 and goes to step ST12. Note here that if the switchover sound SUmc is set different between forward skipping and backward skipping, the skip direction can be confirmed from the sound. If, for example, the switchover sound SUmc is arranged to be output once each time the pieces of music is switched in forward skipping and twice consecutively each time they are switched in backward skipping, the skip direction can be known from the switchover sound SUmc. At step ST12, the process decides whether a button operation is finished. If the button operation is continued, the process returns to step ST9. If the button operation is finished, the process goes to step ST19.

Continuing to operate the backward skip button allows the processing from steps ST9 to ST12 to be repeated, thereby selecting a piece of music from those in the reproduction list in a direction opposite to a reproduction order of the pieces of music.

Thereafter, if the first piece of music in the reproduction order is selected, the process goes from step ST10 to step ST13. At step ST13, the process outputs the identification sound SUft indicating that the first piece is selected from the sound output portion 16 and goes to step ST19.

If consecutive skip operations are thus performed in the direction opposite to the reproduction order of the pieces of music, as shown in FIG. 4B, the switchover sound SUmc is output for each time when the switchover of pieces of music is performed until the second piece “MC2” is encountered. If the switchover is made from the second piece to the first piece “MC1”, the identification sound SUft is output. Thus, the user may decide that the pieces of music are switched to the first one based on the identification sound SUft.

If the button operation time is not longer than a preset lapse of time, the process goes from step ST1 to step ST14, to decide whether the forward skip button is pressed. If such is the case, the process goes to step ST15. Otherwise, the process goes to step ST18.

At step ST15, the process decides whether the current reproduced piece of music is the last one. If such is not the case, the process goes to step ST16 and, otherwise, to step ST17.

At step ST16, the process runs forward over the pieces of music to select a next piece of music in order in the reproduction list and set it as the reproduced piece of music and goes to step ST19. At step ST17, the process sets the first piece of music in order, which is a piece of music to be reproduced first, as the reproduced piece of music and goes to step ST19.

Further, if it decides at step ST14 that the backward skip button is operated, the process goes to step ST18, where it runs backward over the pieces of music to select a piece of music immediately previous in order in the reproduction list and set it as the reproduced piece of music. Then, the process goes to step ST19. At step ST19, the process starts reproducing the reproduced piece of music. Note here that in a case where the pieces of music are skipped circularly in a reproduction order or an order opposite to the reproduction order, if skipping is performed in the opposite order when one piece of music is being reproduced, the process runs backward over the pieces of music to set the piece “MC5” that is to be reproduced last, as the reproduced piece of music.

Thus, outputting the identification sound SUft or the switchover sound SUmc from the sound output portion 16 allows a piece of music to be reproduced first or a piece of music having a desired turn in reproduction order to be selected without referencing the display, based on the output identification sound SUft or switchover sound SUmc. Especially when consecutive skip operations are being performed in the reproduction order or the reversed reproduction order circularly, usefully it is possible to easily decide the piece of music to be reproduced first. Further, when the piece of music to be reproduced first is selected, this piece is reproduced, so that it is possible to lightly decide that the piece to be reproduced first is selected. For example, in a case where a switchover speed for the pieces of music during skipping is different form each other depending on a melody performance time, if the performance time of the first piece “MC1” is short, the piece “MC1” is switched to the piece “MC2” too fast during skipping, so that it may be difficult to decide whether the current piece of music is the first one “MC1”. However, in the present invention, when the piece “MC1” is selected, this piece is reproduced, so that it is possible to lightly decide that the piece of music to be reproduced first is selected, irrespective of the performance time of the piece “MC1”. Further, it is possible to recognize the piece of music to be reproduced first or select a piece of music having a desired turn in reproduction order without providing a display to the apparatus for reproducing sound, thereby constituting the apparatus inexpensively.

Although the above embodiments have been described with reference to a case where the recording medium constituted of a semiconductor memory is used, the present invention is not limited to this. A recording medium capable of random access may be used such as an optical disc or magnetic disk that utilizes light or magnetism respectively in recording and reproduction. For example, also in a case where the pieces of music are skipped on the basis of TOC information using a compact disc or a mini-disc as the recording medium, if the identification sound SUft or the switchover sound SUmc is output and a piece of music to be reproduced first in reproduction list is reproduced when the piece is selected as described above, it is possible to select the piece of music to be reproduced first or a piece of music having a desired turn in reproduction order without referencing any display.

Further, in a case where a header having information indicative of a reproduction order of the pieces of music is added to data of that piece of music, it is possible to detect this header and perform skip operations with watching the reproduction order of the pieces of music, thereby outputting the identification sound SUft or the switchover sound SUmc and reproducing the piece of music to be reproduced first.

Furthermore, the signal for the sound contents recorded in the recording medium is not limited to that of a piece of music. For example, also in a case where a proceeding or a sound note is recorded as sound contents, when the identification sound SUft or the switchover sound SUmc is output and the sound contents to be reproduced first is selected, the sound contents can be reproduced, thereby easily selecting the sound contents to be reproduced first and the sound contents having a desired turn in the reproduction order.

As described above, according to the present invention, selecting sound contents to be reproduced first and the sound contents having a desired turn in reproduction order without using display, thus qualifying itself for use in an inexpensive portable sound reproduction device.

While the foregoing specification has described preferred embodiment(s) of the present invention, one skilled in the art may make many modifications to the preferred embodiment without departing from the invention in its broader aspects. The appended claims therefore are intended to cover all such modifications as fall within the true scope and spirit of the invention.

1. An apparatus for reproducing sound comprising:
a reproducer for reproducing plural sound contents in accordance with a reproduction order thereof;
an operating device for operating to skip the sound contents reproduced by said reproducer;
a controller for skipping said sound contents circularly in any one of a reproduction order thereof and a reversed order of said reproduction order in accordance with an operation of said operating device to select new ones from the sound contents, and for controlling said reproducer to reproduce the newly selected sound contents; and
a sound-outputting device for outputting the reproduced sound contents,
wherein when the operating device operates to skip said sound contents and the controller selects the sound contents, said contents being reproduced first, said controller controls said sound-outputting device to output identification sound from said sound-outputting device, said identification sound deciding that the sound contents of a first reproduction order are selected.

2. The apparatus according to claim 1, wherein when the sound contents of a first reproduction order are selected, said controller stops skipping said sound contents and controls said reproducer to reproduce the sound contents.

3. The apparatus according to claim 1, wherein every time when said sound contents are skipped and the sound contents that are different from said sound contents of the first reproduction order are selected newly, said controller controls said sound-outputting device to output switchover sound from said sound-outputting device, said switchover sound being different from said identification sound.

4. An apparatus for reproducing sound comprising:
a reproducer for reproducing plural sound contents in accordance with a reproduction order thereof;
an operating device for operating to skip the sound contents reproduced by said reproducer;
a controller for skipping said sound contents circularly in any one of a reproduction order thereof and a reversed order of said reproduction order in accordance with an operation of said operating device to select new ones from the sound contents, and for controlling said reproducer to reproduce the newly selected sound contents; and
a sound-outputting device for outputting the reproduced sound contents,
wherein when the operating device operates to skip said sound contents and the controller selects the sound contents, said contents being reproduced first, said controller stops skipping said sound contents and controls said reproducer to reproduce the sound contents.

5. A method for reproducing plural sound contents in accordance with a reproduction order thereof, said method comprising;
a decision step of deciding whether an operation is performed to skip said sound contents to be reproduced circularly in any one of a reproduction order thereof and a reversed order of said reproduction order; and
an identification sound output step of, when it is decided by said decision step that the operation to skip said sound contents is performed, circularly skipping said sound contents in any one of said reproduction order and said reversed order and, when the sound contents of a first reproduction order are selected, outputting identification sound, said identification sound deciding that said sound contents of the first reproduction order are selected.

6. The method according to claim 5, comprising a reproduction step of, when said sound contents of the first reproduction order are selected, stopping skipping said sound contents and then, reproducing the sound contents.

7. The method according to claim 5, comprising a switchover sound output step of, every time when said sound contents are being skipped and the sound contents that are different from said sound contents of the first reproduction order are selected newly, outputting switchover sound different from said identification sound.

8. A method for reproducing plural sound contents in accordance with a reproduction order thereof, said method comprising;
a decision step of deciding whether an operation is performed to skip said sound contents to be reproduced circularly in any one of a reproduction order thereof and a reversed order of said reproduction order; and
a reproduction step of, when it is decided by said decision step that the operation to skip said sound contents is performed, circularly skipping said sound contents in any one of said reproduction order and the reversed order of said reproduction order and, when the sound contents of the first reproduction order are selected, stopping skipping said sound contents and reproducing the sound contents.
